(19) United States
(12) Patent Application Publication
(10) Pub. No.: US 2026/0061644 A1
(43) Pub. Date: Mar. 5, 2026

(54) CUTTER HEAD DEVICE HAVING GUIDE STRUCTURE

(71) Applicant: NINGBO ICLIPPER ELECTRIC APPLIANCE CO.,LTD, Ningbo (CN)

(72) Inventor: Haoze WU, Ningbo (CN)

(21) Appl. No.: 19/023,437

(22) Filed: Jan. 16, 2025

(30) Foreign Application Priority Data
Aug. 30, 2024 (CN) 2024221245154

(51) Int. Cl. B26B 19/06; B26B 19/38; B26B 19/40

(52) U.S. Cl. CPC B26B 19/06; B26B 19/3846; B26B 19/40

(57) ABSTRACT

A cutter head device having a guide structure comprises a fixed blade holder, a movable blade holder, a fixed blade, a movable blade and a torsion spring; the fixed blade is fixedly connected to the fixed blade holder, and the movable blade is fixedly connected to the movable blade holder; the torsion spring is fixedly mounted on the fixed blade holder; a guide shaft is fixedly mounted on the fixed blade holder, the movable blade holder is provided with a mounting base and a guide groove; by arranging the guide shaft on the fixed blade holder and arranging the movable blade holder on the guide shaft in a sliding manner, the frictional force produced when the movable blade holder transversely reciprocates is reduced, the functional life of the cutter head device is prolonged, and the smooth movement of the cutter head device is achieved.

### TECHNICAL FIELD

This invention generally relates to the technical field of electric hair cutters, and more particularly, to a cutter head device having a guide structure.

### BACKGROUND

As an electric tool for cutting hair, electric hair cutters are widely used in people’s daily lives. For a conventional cutter head device, a movable blade is propelled by a motor to reciprocate relative to a fixed blade through an eccentric mechanism, so that the hair cutting is realized. To keep the movable blade transversely reciprocating relative to the fixed blade, a transversely-arranged guide groove is formed in a fixed blade holder, and a movable blade holder is connected to a guide block. Through the interaction between the guide block and the guide groove in a guided and limited manner, the transverse reciprocating movement of the movable blade relative to the fixed blade is achieved. The guide block is made of a plastic material. When the guide block reciprocates in the guide groove of the fixed blade holder, the large frictional force leads to severe wear of the guide block such that the functional life of the cutter head device is greatly shortened. In addition, due to the large frictional force produced when the guide block moves back and forth in the guide groove of the fixed blade holder, it is difficult for the cutter head device to cut harder hair. Therefore, it is urgent to develop a novel cutter head device.

### SUMMARY

The purpose of the present invention is to provide a cutter head device having a guide structure. By arranging the guide shaft on the fixed blade holder and arranging the movable blade holder on the guide shaft in a sliding manner, the frictional force produced when the movable blade holder transversely reciprocates is reduced, the functional life of the cutter head device is prolonged, and the smooth movement of the cutter head device is achieved. Compared with the prior art, the cutter head device of the present invention facilitates the cutting of harder hair.

To achieve the above purpose, the present invention adopts the following technical solution: a cutter head device having a guide structure comprises a fixed blade holder, a movable blade holder, a fixed blade, a movable blade and a torsion spring; the fixed blade is fixedly connected to the fixed blade holder, and the movable blade is fixedly connected to the movable blade holder; the torsion spring is fixedly mounted on the fixed blade holder, and elastic feet at two ends of the torsion spring act on the movable blade holder or the movable blade to enable the movable blade to be attached to the fixed blade; a guide shaft is fixedly mounted on the fixed blade holder, the movable blade holder is provided with a mounting base, and a guide groove for interacting with the guide shaft is formed in the mounting base, thereby allowing the movable blade holder and the movable blade to transversely reciprocate along the guide shaft.

In another embodiment of the present invention, a storage cavity is arranged in the mounting base, and an oil storage block is fixedly mounted in the storage cavity. The oil storage block is provided with a first through hole for interacting with the guide shaft, and the movable blade holder and the oil storage block mounted in the movable blade holder are capable of synchronously moving along with the guide shaft.

In another embodiment of the present invention, the oil storage block adopts an oil storage sponge.

In another embodiment of the present invention, a front end of the fixed blade holder is provided with two corner portions. One corner portion is provided with a blind hole with an opening in an inner end, and the diameter of the blind hole is matched with the guide shaft. The other corner portion is provided with an assembly hole, and the assembly hole comprises an inner end mounting hole and an outer end threaded hole. The guide shaft is mounted in the blind hole and the assembly hole. A top screw is in threaded connection with the interior of the threaded hole, and the other side of the guide shaft abuts against an inner end surface of the blind hole by means of the top crew.

In another embodiment of the present invention, the periphery of the top screw is in threaded connection with the threaded hole, and an outer end surface of the top screw is provided with a linear groove or a cross groove for facilitate the screwing.

In another embodiment of the present invention, the other end of the movable blade holder away from the movable blade is provided with limiting structures in one-to-one correspondence with the elastic feet at the two ends of the torsion spring. The limiting structure comprises two limiting protrusions, and a limiting groove for limiting the elastic feet of the torsion spring is formed between the two limiting protrusions.

In another embodiment of the present invention, the movable blade holder and the movable blade are provided with a position adjusting structure. The relative position between the movable blade and the movable blade holder is adjusted by the position adjusting structure. The position adjusting structure comprises a mounting block, a nut member and a screw. The mounting block is arranged at a lower end of the movable blade, the mounting block is provided with an accommodating groove, and the nut member is mounted in the accommodating groove in a non-rotating manner. The movable blade holder is provided with a strip-shaped hole. The screw passes through the strip-shaped hole and is in threaded connection with the nut member for fixedly connecting the movable blade holder to the movable blade. The movable blade is provided with a second through hole for allowing the screw to extend into.

In another embodiment of the present invention, a lower end of the accommodating groove is a strip-shaped groove, a lower end of the nut member is provided with a strip-shaped block for interacting with the strip-shaped groove, and the nut member is mounted in the accommodating groove in a non-rotating manner by means of the strip-shaped block and the strip-shaped groove.

In another embodiment of the present invention, one end of the fixed blade corresponding to the movable blade is provided with an avoidance space for allowing the mounting block to transversely reciprocate.

In another embodiment of the present invention, there are two position adjusting structures that are symmetrically arranged on two sides of the movable blade holder.

Compared with the prior art, the present invention has the following advantages:

1. By arranging the guide shaft on the fixed blade holder and arranging the movable blade holder on the guide shaft in a sliding manner, the frictional force produced when the movable blade holder transversely reciprocates is reduced, the functional life of the cutter head device is prolonged, and the smooth movement of the cutter head device is achieved; compared with the prior art, the cutter head device of the present invention facilitates the cutting of harder hair;

2. The movable blade holder and the movable blade are provided with a position adjusting structure for adjusting the relative position between the movable blade and the movable blade holder, thereby further adjusting the relative position between the movable blade and the fixed blade such that the length of cut hair is adjusted.

### BRIEF DESCRIPTION OF THE DRAWINGS

FIG. 1 is a schematic diagram illustrating an exemplary overall structure of the present invention;

FIG. 2 is a schematic diagram illustrating an explosive view of the present invention;

FIG. 3 is a schematic diagram illustrating a top view of the present invention;

FIG. 4 is a schematic diagram illustrating a sectional view of portion B in FIG. 3;

FIG. 5 is a schematic diagram illustrating a sectional view of portion A in FIG. 3;

FIG. 6 is a schematic diagram illustrating an exemplary structure of the mounting block; and

FIG. 7 is a schematic diagram illustrating an exemplary structure of the movable blade holder of the present invention.

In Figures: 10-Fixed Blade Holder, 11-Corner Portion, 12-Top Screw, 20-Movable Blade Holder, 211-Guide Groove, 212-Storage Cavity, 22-Oil Storage Block, 23-Limiting Structure, 24-Strip-shaped Hole, 30-Fixed Blade, 31-Avoidance Space, 40-Movable Blade, 50-Torsion Spring, 51-Elastic Foot, 60-Guide Shaft, 70-Position Adjusting Structure, 71-Mounting Block, 711-Accommodating Groove, 72-Nut Member, 73-Screw.

### DETAILED DESCRIPTION

Drawings are combined hereinafter to further elaborate the technical solution of the present invention.

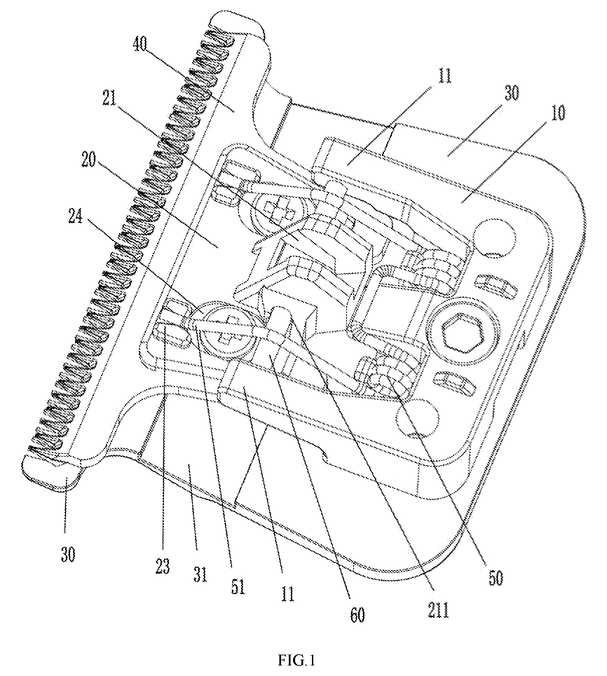

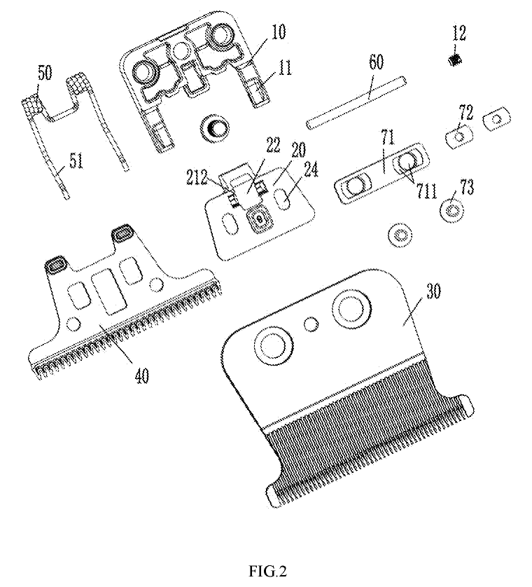

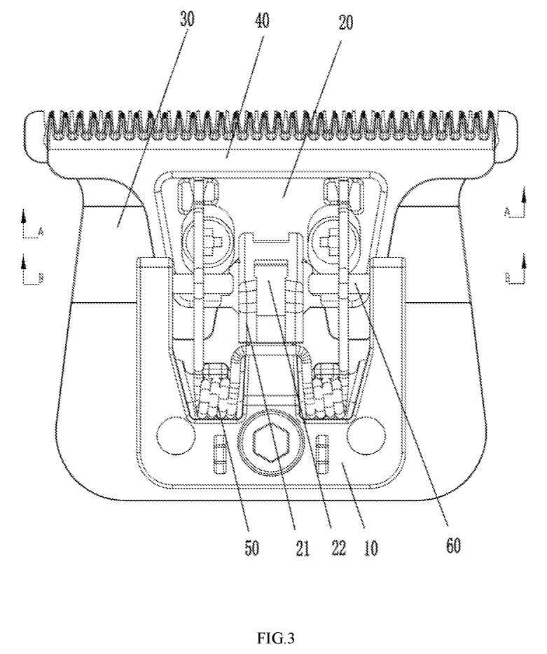

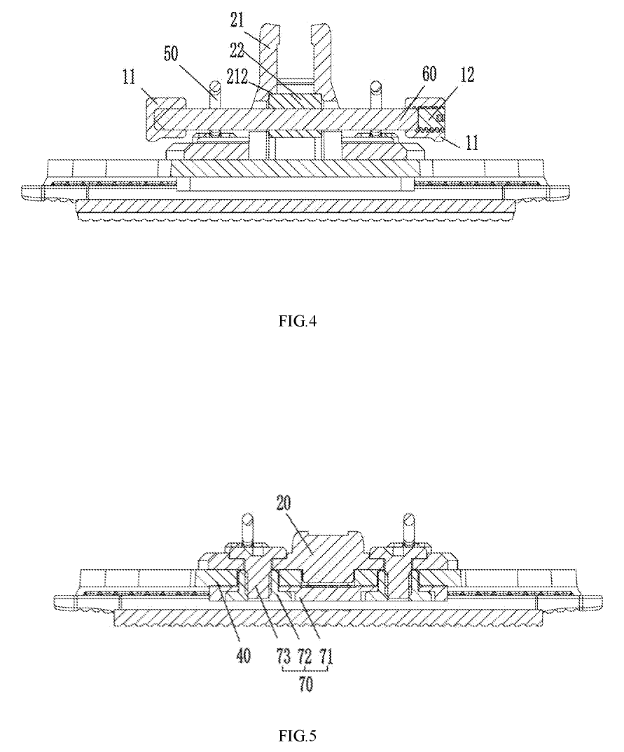

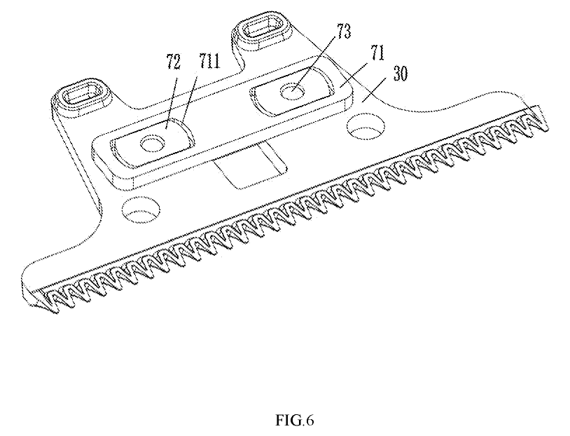

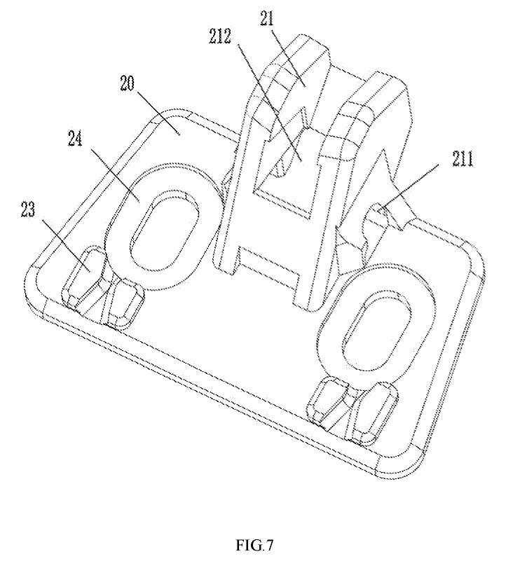

Referring to FIGS. 1-7, the cutter head device having a guide structure comprises a fixed blade holder 10, a movable blade holder 20, a fixed blade 30, a movable blade 40 and a torsion spring 50. The aforesaid is the basic structure of the present invention.

The fixed blade 30 is fixedly connected to the fixed blade holder 10, and the movable blade 40 is fixedly connected to the movable blade holder 20. The torsion spring 50 is fixedly mounted on the fixed blade holder 10, and elastic feet 51 at two ends of the torsion spring 50 act on the movable blade holder 20 or the movable blade 40 to enable the movable blade 40 to be attached to the fixed blade 30. A guide shaft 60 is fixedly mounted on the fixed blade holder 10, the movable blade holder 20 is provided with a mounting base 21, and a guide groove 211 for interacting with the guide shaft 60 is formed in the mounting base 21, thereby allowing the movable blade holder 20 and the movable blade 40 to transversely reciprocate along the guide shaft 60 such that the consistency of hair cutting is ensured.

According to the cutter head device, the guide shaft 60 is arranged on the fixed blade holder 10 and the movable blade holder 20 is slidably arranged on the guide shaft 60, so that the friction produced when the movable blade holder 20 transversely reciprocates is reduced, the functional life of the cutter head device is prolonged, and the movement of the cutter head device becomes more smooth. Compared with the prior art, the cutter head device facilitates the cutting of harder hair.

In some embodiments, a storage cavity 212 is arranged in the mounting base 21, and an oil storage block 22 is fixedly mounted in the storage cavity 212. The oil storage block 22 is provided with a first through hole for interacting with the guide shaft 60, and the movable blade holder 20 and the oil storage block 22 mounted in the movable blade holder 20 are capable of synchronously moving along with the guide shaft 60. Further, the oil storage block 22 adopts an oil storage sponge, and the oil storage block 22 plays a role of lubrication. In this way, the movable blade holder 20 transversely reciprocates along with the guide shaft 60, thereby avoiding the blocking problem when the movable blade holder 20 transversely reciprocates.

In some embodiments, a front end of the fixed blade holder 10 is provided with two corner portions 11. One corner portion 11 is provided with a blind hole with an opening in an inner end, and the diameter of the blind hole is matched with the guide shaft 60. The other corner portion 11 is provided with an assembly hole, and the assembly hole comprises an inner end mounting hole and an outer end threaded hole. The guide shaft 60 is mounted in the blind hole and the assembly hole. A top screw 12 is in threaded connection with the interior of the threaded hole, and the other side of the guide shaft 60 abuts against an inner end surface of the blind hole by means of the top crew 12. Through the aforesaid arrangement, the fixed blade holder 10 is conveniently processed, and the guide shaft 60 is conveniently assembled.

Further, the periphery of the top screw 12 is in threaded connection with the threaded hole, and an outer end surface of the top screw 12 is provided with a linear groove or a cross groove for facilitate the screwing. During assembly, the top screw 12 may be screwed inwards by using a tool, so that the guide shaft 60 is fixedly mounted at a position abutting against the inner end surface of the blind hole.

In some embodiments, the other end of the movable blade holder 20 away from the movable blade 40 is provided with limiting structures 23 in one-to-one correspondence with the elastic feet 51 at the two ends of the torsion spring 50. The limiting structure 23 comprises two limiting protrusions, and a limiting groove for limiting the elastic feet 51 of the torsion spring 50 is formed between the two limiting protrusions. By means of the limiting groove, the elastic feet 51 of the torsion spring 50 is prevented from separating from the movable blade 40 when the movable blade 40 transversely reciprocates, so that the movable blade 40 is better attached to the fixed blade 30. By providing the limiting structure 23, the elastic feet 51 of the torsion spring 50 always presses against the movable blade 40, thereby ensuring that the movable blade 40 is always attached to the fixed blade 30.

In some embodiments, the movable blade holder 20 and the movable blade 40 are provided with a position adjusting structure 70. The relative position between the movable blade 40 and the movable blade holder 20 is adjusted by the position adjusting structure 70. The position adjusting structure 70 comprises a mounting block 71, a nut member 72 and a screw 73. The mounting block 71 is arranged at a lower end of the movable blade 40, the mounting block 71 is provided with an accommodating groove 711, and the nut member 72 is mounted in the accommodating groove 711 in a non-rotating manner. The movable blade holder 20 is provided with a strip-shaped hole 24. The screw 73 passes through the strip-shaped hole 24 and is in threaded connection with the nut member 72 for fixedly connecting the movable blade holder 20 to the movable blade 40. The movable blade 40 is provided with a second through hole for allowing the screw 73 to extend into.

According to the cutter head structure, the movable blade holder 20 and the movable blade 40 is provided with the position adjusting structure 70 in an interacting manner for adjusting the relative position between the movable blade 40 and the movable blade holder 20, thereby further adjusting the relative position between the movable blade 40 and the fixed blade 30 such that the length of the cut hair is adjusted.

Further, a lower end of the accommodating groove 711 is a strip-shaped groove, a lower end of the nut member 72 is provided with a strip-shaped block for interacting with the strip-shaped groove, and the nut member 72 is mounted in the accommodating groove 711 in a non-rotating manner by means of the strip-shaped block and the strip-shaped groove. Through adopting the aforesaid arrangement, the nut member 72 is prevented from rotating when the screw 73 is assembled, thereby improving the assembly efficiency of the movable blade 40 and the movable blade holder 20.

Further, one end of the fixed blade 30 corresponding to the movable blade 40 is provided with an avoidance space 31 for allowing the mounting block 71 to transversely reciprocate, so that the mounting block 71 is prevented from interfering with the fixed blade 30 when the mounting block 71 transversely moves along with the movable blade 40.

There are two position adjusting structures 70 that are symmetrically arranged on two sides of the movable blade holder 20, so that the movable blade holder 20 and the movable blade 40 are connected more stably.

The above are merely preferred embodiments of the present invention, and therefore, equivalent changes or modifications made according to the structure, feature and principle described in the present invention shall fall into the scope defined by the claims of the present invention.

What is claimed is:

1. A cutter head device having a guide structure, comprising:
a fixed blade holder (10),
a movable blade holder (20),
a fixed blade (30),
a movable blade (40), and
a torsion spring (50), wherein the fixed blade (30) is fixedly connected to the fixed blade holder (10), wherein the movable blade (40) is fixedly connected to the movable blade holder (20), wherein the torsion spring (50) is fixedly mounted on the fixed blade holder (10), wherein elastic feet (51) at two ends of the torsion spring (50) act on the movable blade holder (20) or the movable blade (40) to enable the movable blade (40) to be attached to the fixed blade (30), wherein a guide shaft (60) is fixedly mounted on the fixed blade holder (10), wherein the movable blade holder (20) is provided with a mounting base (21), and wherein a guide groove (211) for interacting with the guide shaft (60) is formed in the mounting base (21), thereby allowing the movable blade holder (20) and the movable blade (40) to transversely reciprocate along the guide shaft (60).

2. The cutter head device having a guide structure of claim 1, wherein a storage cavity (212) is arranged in the mounting base (21), wherein an oil storage block (22) is fixedly mounted in the storage cavity (212), wherein the oil storage block (22) is provided with a first through hole for interacting with the guide shaft (60), and wherein the movable blade holder (20) and the oil storage block (22) mounted in the movable blade holder (20) are capable of synchronously moving along with the guide shaft (60).

3. The cutter head device having a guide structure of claim 2, wherein the oil storage block (22) adopts an oil storage sponge.

4. The cutter head device having a guide structure of claim 1, wherein a front end of the fixed blade holder (10) is provided with two corner portions (11), wherein one corner portion (11) is provided with a blind hole with an opening in an inner end, wherein the diameter of the blind hole is matched with the guide shaft (60), wherein the other corner portion (11) is provided with an assembly hole, and the assembly hole comprises:
an inner end mounting hole and an outer end threaded hole, wherein the guide shaft (60) is mounted in the blind hole and the assembly hole, wherein a top screw (12) is in threaded connection with the interior of the threaded hole, and wherein the other side of the guide shaft (60) abuts against an inner end surface of the blind hole by means of the top crew (12).

5. The cutter head device having a guide structure of claim 4, wherein the periphery of the top screw (12) is in threaded connection with the threaded hole, and wherein an outer end surface of the top screw (12) is provided with a linear groove or a cross groove for facilitate the screwing.

6. The cutter head device having a guide structure of claim 1, wherein the other end of the movable blade holder (20) away from the movable blade (40) is provided with limiting structures (23) in one-to-one correspondence with the elastic feet (51) at the two ends of the torsion spring (50), and wherein the limiting structure (23) comprises:
two limiting protrusions, and a limiting groove for limiting the elastic feet (51) of the torsion spring (50) is formed between the two limiting protrusions.

7. The cutter head device having a guide structure of claim 1, wherein the movable blade holder (20) and the movable blade (40) are provided with a position adjusting structure (70), wherein the relative position between the movable blade (40) and the movable blade holder (20) is adjusted by the position adjusting structure (70), wherein the position adjusting structure (70) comprises:
a mounting block (71), a nut member (72) and a screw (73), wherein the mounting block (71) is arranged at a lower end of the movable blade (40), wherein the mounting block (71) is provided with an accommodating groove (711), wherein the nut member (72) is mounted in the accommodating groove (711) in a non-rotating manner, wherein the movable blade holder (20) is provided with a strip-shaped hole (24), wherein the screw (73) passes through the strip-shaped hole (24) and is in threaded connection with the nut member (72) for fixedly connecting the movable blade holder (20) to the movable blade (40), and wherein the movable blade (40) is provided with a second through hole for allowing the screw (73) to extend into.

8. The cutter head device having a guide structure of claim 2, wherein the movable blade holder (20) and the movable blade (40) are provided with a position adjusting structure (70), wherein the relative position between the movable blade (40) and the movable blade holder (20) is adjusted by the position adjusting structure (70), wherein the position adjusting structure (70) comprises:
a mounting block (71), a nut member (72) and a screw (73), wherein the mounting block (71) is arranged at a lower end of the movable blade (40), wherein the mounting block (71) is provided with an accommodating groove (711), wherein the nut member (72) is mounted in the accommodating groove (711) in a non-rotating manner, wherein the movable blade holder (20) is provided with a strip-shaped hole (24), wherein the screw (73) passes through the strip-shaped hole (24) and is in threaded connection with the nut member (72) for fixedly connecting the movable blade holder (20) to the movable blade (40), and wherein the movable blade (40) is provided with a second through hole for allowing the screw (73) to extend into.

9. The cutter head device having a guide structure of claim 3, wherein the movable blade holder (20) and the movable blade (40) are provided with a position adjusting structure (70), wherein the relative position between the movable blade (40) and the movable blade holder (20) is adjusted by the position adjusting structure (70), wherein the position adjusting structure (70) comprises:
a mounting block (71), a nut member (72) and a screw (73), wherein the mounting block (71) is arranged at a lower end of the movable blade (40), wherein the mounting block (71) is provided with an accommodating groove (711), wherein the nut member (72) is mounted in the accommodating groove (711) in a non-rotating manner, wherein the movable blade holder (20) is provided with a strip-shaped hole (24), wherein the screw (73) passes through the strip-shaped hole (24) and is in threaded connection with the nut member (72) for fixedly connecting the movable blade holder (20) to the movable blade (40), and wherein the movable blade (40) is provided with a second through hole for allowing the screw (73) to extend into.

10. The cutter head device having a guide structure of claim 4, wherein the movable blade holder (20) and the movable blade (40) are provided with a position adjusting structure (70), wherein the relative position between the movable blade (40) and the movable blade holder (20) is adjusted by the position adjusting structure (70), wherein the position adjusting structure (70) comprises:
a mounting block (71), a nut member (72) and a screw (73), wherein the mounting block (71) is arranged at a lower end of the movable blade (40), wherein the mounting block (71) is provided with an accommodating groove (711), wherein the nut member (72) is mounted in the accommodating groove (711) in a non-rotating manner, wherein the movable blade holder (20) is provided with a strip-shaped hole (24), wherein the screw (73) passes through the strip-shaped hole (24) and is in threaded connection with the nut member (72) for fixedly connecting the movable blade holder (20) to the movable blade (40), and wherein the movable blade (40) is provided with a second through hole for allowing the screw (73) to extend into.

11. The cutter head device having a guide structure of claim 5, wherein the movable blade holder (20) and the movable blade (40) are provided with a position adjusting structure (70), wherein the relative position between the movable blade (40) and the movable blade holder (20) is adjusted by the position adjusting structure (70), wherein the position adjusting structure (70) comprises:
a mounting block (71), a nut member (72) and a screw (73), wherein the mounting block (71) is arranged at a lower end of the movable blade (40), wherein the mounting block (71) is provided with an accommodating groove (711), wherein the nut member (72) is mounted in the accommodating groove (711) in a non-rotating manner, wherein the movable blade holder (20) is provided with a strip-shaped hole (24), wherein the screw (73) passes through the strip-shaped hole (24) and is in threaded connection with the nut member (72) for fixedly connecting the movable blade holder (20) to the movable blade (40), and wherein the movable blade (40) is provided with a second through hole for allowing the screw (73) to extend into.

12. The cutter head device having a guide structure of claim 6, wherein the movable blade holder (20) and the movable blade (40) are provided with a position adjusting structure (70), wherein the relative position between the movable blade (40) and the movable blade holder (20) is adjusted by the position adjusting structure (70), wherein the position adjusting structure (70) comprises:
a mounting block (71), a nut member (72) and a screw (73), wherein the mounting block (71) is arranged at a lower end of the movable blade (40), wherein the mounting block (71) is provided with an accommodating groove (711), wherein the nut member (72) is mounted in the accommodating groove (711) in a non-rotating manner, wherein the movable blade holder (20) is provided with a strip-shaped hole (24), wherein the screw (73) passes through the strip-shaped hole (24) and is in threaded connection with the nut member (72) for fixedly connecting the movable blade holder (20) to the movable blade (40), and wherein the movable blade (40) is provided with a second through hole for allowing the screw (73) to extend into.

13. The cutter head device having a guide structure of claim 7, wherein a lower end of the accommodating groove (711) is a strip-shaped groove, wherein a lower end of the nut member (72) is provided with a strip-shaped block for interacting with the strip-shaped groove, and wherein the nut member (72) is mounted in the accommodating groove (711) in a non-rotating manner by means of the strip-shaped block and the strip-shaped groove.

14. The cutter head device having a guide structure of claim 7, wherein one end of the fixed blade (30) corresponding to the movable blade (40) is provided with an avoidance space (31) for allowing the mounting block (71) to transversely reciprocate.

15. The cutter head device having a guide structure of claim 1, wherein there are two position adjusting structures (70) that are symmetrically arranged on two sides of the movable blade holder (20).
